(19) United States
(12) Patent Application Publication
(10) Pub. No.: US 2021/0170870 A1
(43) Pub. Date: Jun. 10, 2021

(54) METHOD OF CONTROLLING DRIVING OF VEHICLE BY ESTIMATING FRICTIONAL COEFFICIENT OF ROAD SURFACE

(71) Applicants: HYUNDAI MOTOR COMPANY, Seoul (KR); KIA MOTORS CORPORATION, Seoul (KR)

(72) Inventors: Ji Won Oh, Hwaseong-si (KR); Jeong Soo Eo, Hwaseong-si (KR)

(21) Appl. No.: 16/943,475

(22) Filed: Jul. 30, 2020

(30) Foreign Application Priority Data
Dec. 5, 2019 (KR) 10-2019-0160283

(51) Int. Cl. B60K 23/08; B60W 30/18; B60W 40/068

(52) U.S. Cl. CPC B60K 23/0808; B60W 30/18172; B60W 40/068; B60W 2552/40; B60W 2720/403; B60W 2540/10; B60W 2540/12; B60W 2540/18; B60K 2023/085; B60W 2520/10

(57) ABSTRACT

The present disclosure provides a method of controlling driving of a vehicle by estimating a road frictional coefficient, the method including distributing torque to a front wheel and a rear wheel to satisfy required torque for driving, by a controller, in a four-wheel drive (4WD) vehicle including a front wheel driving device and a rear wheel driving device installed therein, and performing torque excitation control for increasing torque applied to one of the front wheel and the rear wheel to which the torque is distributed while the vehicle is driven, and simultaneously, changing torque applied to a remaining one of the front wheel and the rear wheel in such a way that the sum of front wheel torque and rear wheel torque satisfies required torque, by the controller.

### CROSS REFERENCE TO RELATED APPLICATIONS

This application claims under 35 U.S.C. § 119(a) the benefit of priority to Korean Patent Application No. 10-2019-0160283 filed on Dec. 5, 2019, the entire contents of which are incorporated herein by reference.

### BACKGROUND

### (a) Technical Field

The present disclosure relates to a method of controlling driving of a vehicle, and more particularly, to a method of estimating a road frictional coefficient while a vehicle is driven and performing driving control based on the estimated road frictional coefficient to prevent a dangerous situation on a low-friction road surface.

### (b) Background Art

As an electronic control system for enhancing safety while a vehicle travels, an anti-lock brake system (ABS) for preventing brake lock due to wheel slip on a slippery road surface when the vehicle brakes, a traction control system (TCS) for controlling driving force or braking force when the vehicle suddenly accelerates or suddenly decelerates to prevent wheel slip, an electronic stability program (ESP) for stably controlling stability of the vehicle, or the like has been known.

Thereamong, the TCS is an active safety device that prevents excessive slip of a driving wheel to prevent vehicle spin while a vehicle starts or accelerates on a low-friction road surface or an asymmetric road surface, and enhances starting and accelerating capability, and steering safety of the vehicle.

The TCS controls driving force or braking force of the vehicle to control a speed of a driving wheel when excessive driving force is generated and a phenomenon such as wheel slip occurs when the vehicle starts or accelerates on a slippery road surface, thereby maximizing an acceleration of the vehicle.

Here, the driving force of the vehicle may refer to torque output by a vehicle driving source, and the vehicle driving source may be a motor (a pure electric vehicle or a fuel cell vehicle), an engine (an internal combustion engine vehicle), or a motor and an engine (a hybrid vehicle).

For example, in a motor driven vehicle such as a pure electric vehicle, a fuel cell vehicle, or a hybrid vehicle, a target driving wheel speed for obtaining optimal driving force at a driving wheel may be determined depending on the amount of slip that occurs between a driving wheel and a road surface, a road frictional coefficient, or the like, and motor torque may be controlled to follow the determined target driving wheel speed.

When a vehicle turns on a corner road, motor torque may be reduced to reduce the instability of the vehicle, and thus the vehicle may stably turn.

Slip of a vehicle wheel may be calculated based on a speed of an actual vehicle that travels during an operation of the TCS and torque may be adjusted, and the actual vehicle speed and the vehicle wheel speed that are real time information may be used to calculate slip of the vehicle wheel.

In addition to the TCS, an understeer and oversteer phenomenon while a vehicle turns is the largest cause for reducing stability, and the most strong control device for overcoming the problem is an electronic stability program (ESP).

The ESP applies braking force to an internal rear wheel during understeer and applies braking force to an external front wheel during oversteer to ensure yaw stability, which is based on a principle whereby additional braking force is applied to an axis having sufficient grip force on a friction circle to form a braking moment and yaw of the vehicle is controlled through the braking moment.

All behaviors of the vehicle may be determined by frictional force between a tire and a road surface, and thus it may be important to estimate a road frictional coefficient in order to ensure the safety of the vehicle.

However, in reality, it is difficult to define a frictional coefficient before slip between a tire of a vehicle and a road surface, and thus far, research has been conducted into a control technology to be executed when the vehicle becomes dangerous after slip is detected.

An electronic control system for enhancing the driving safety of a vehicle may be, for example, a TCS or an ESP and may recognize a vehicle behavior such as excessive slip between a tire and a road surface or understeer/oversteer and may then control the vehicle to overcome this.

However, there is a method of pre-defining the characteristics of a road surface by a vehicle and predicting and preventing a dangerous vehicle behavior such as excessive slip or understeer/oversteer.

For example, there is a method of defining and previously reacting the characteristics of a driving road in order to prevent a dangerous vehicle behavior such as slip that occurs when a driving vehicle enters a low-friction road period such as a snowy road or black ice in the winter.

However, to this end, it is difficult to apply estimation of a frictional coefficient based on the vehicle behavior, and when the vehicle is controlled after a frictional coefficient is estimated based on an already generated vehicle behavior such as excessive slip or understeer/oversteer, this is simple control in terms of a reactive mode but not proactive control for a preventive mode.

There has been proposed a technology of pre-checking a road state ahead of a vehicle using an image or an ultrasonic sensor and then controlling the vehicle, but the technology disadvantageously requires an additional increase in costs.

### SUMMARY

The present disclosure has been made in an effort to solve the above-described problems associated with the prior art.

In one aspect, the present disclosure provides a method of controlling driving of a vehicle for determining a state of a driving state and preventing a dangerous situation on a low-friction road surface.

In a preferred embodiment, a method of controlling driving of a vehicle by estimating a road frictional coefficient includes distributing torque to a front wheel and a rear wheel to satisfy required torque for driving, by a controller, in a four-wheel drive (4WD) vehicle including a front wheel driving device and a rear wheel driving device installed therein, performing torque excitation control for increasing torque applied to one of the front wheel and the rear wheel to which the torque is distributed while the vehicle is driven, and simultaneously, changing torque applied to a remaining one of the front wheel and the rear wheel to satisfy the required torque by the sum of front wheel torque and rear wheel torque, by the controller, and during the torque excitation control, when slip of the front wheel or the rear wheel is detected, estimating a frictional coefficient of a road surface with which a corresponding vehicle wheel is grounded from torque and normal force of a vehicle wheel at which slip is detected, by the controller.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1 and 2 are diagrams for explaining a principle and method of estimating a road frictional coefficient according to the present disclosure;

FIG. 3 is a diagram illustrating the configuration of a control system for estimating a road frictional coefficient and controlling driving of a vehicle according to the present disclosure; and

FIGS. 4A, 4B, 4C, 5, 6A, 6B, and 6C are flowcharts showing estimation of a road frictional coefficient and control of driving of a vehicle according to the present disclosure.

### DETAILED DESCRIPTION

Exemplary embodiments of the present disclosure are described in detail so as for those of ordinary skill in the art to easily implement the present disclosure with reference to the accompanying drawings. However, the present disclosure may be implemented in various different forms and is not limited to these embodiments.

In the specification, when a certain part “includes” a certain component, this indicates that the part may further include another component instead of excluding another component unless there is no different disclosure.

The present disclosure provides a method of controlling driving of a vehicle for preventing excessive slip or dangerous vehicle behavior in a low-friction road surface by estimating a road frictional coefficient and controlling driving of the vehicle based on the estimated road frictional coefficient.

According to the present disclosure, while torque applied to a front wheel and torque applied to rear wheel are independently and continuously changed, a road frictional coefficient indicating frictional characteristics between a tire and a road surface may be estimated using normal force and torque applied to the vehicle wheel at a time point of detecting micro-slip of the vehicle wheel or a time point of detecting a change in equivalent inertia.

According to the present disclosure, the road frictional coefficient may be estimated and then an operation of a driving device may be controlled based on the road frictional coefficient to actively and forcibly reduce a vehicle speed to a safe speed appropriate for the current road frictional coefficient.

The present disclosure may be useful in an eco-friendly vehicle using a motor as a vehicle driving source, i.e., a driving device for driving a vehicle, for example, a motor driven vehicle such as a battery electric vehicle (BEV), a hybrid electric vehicle (HEV), or a fuel cell electric vehicle (FCEV).

The present disclosure may be applied to a four-wheel drive (4WD) vehicle including a front wheel driving device and a rear wheel driving device installed therein and configured to independently apply controlled torque to a front wheel and a rear wheel, respectively, and in more detail, may be applied to an e-4WD vehicle including a front wheel driving motor and a rear wheel driving motor installed therein.

In short, torque applied to the front wheel and torque applied to the rear wheel may be controlled in a vehicle including an e-4WD system installed therein to estimate a road frictional coefficient, and in this regard, when the torque applied to the front wheel and torque applied to the rear wheel are controlled using separate driving motors for estimating a road frictional coefficient, torque distribution control for the front wheel and the rear wheel may be performed in such a way that the sum of the torque applied to the front wheel and torque applied to the rear wheel follows required torque when the vehicle is driven.

Needless to say, application and distribution of the torque applied to the front wheel and torque applied to the rear wheel may be performed by controlling an operation of the front wheel driving motor and the rear wheel driving motor that applies torque to a corresponding vehicle wheel.

According to the present disclosure, an operation of a driving device needs to be controlled and the torque applied to the vehicle wheel needs to be changed in a procedure of estimating the road frictional coefficient, and thus, both the road frictional coefficient estimation procedure and the vehicle deceleration procedure may be performed only when being selected by a driver.

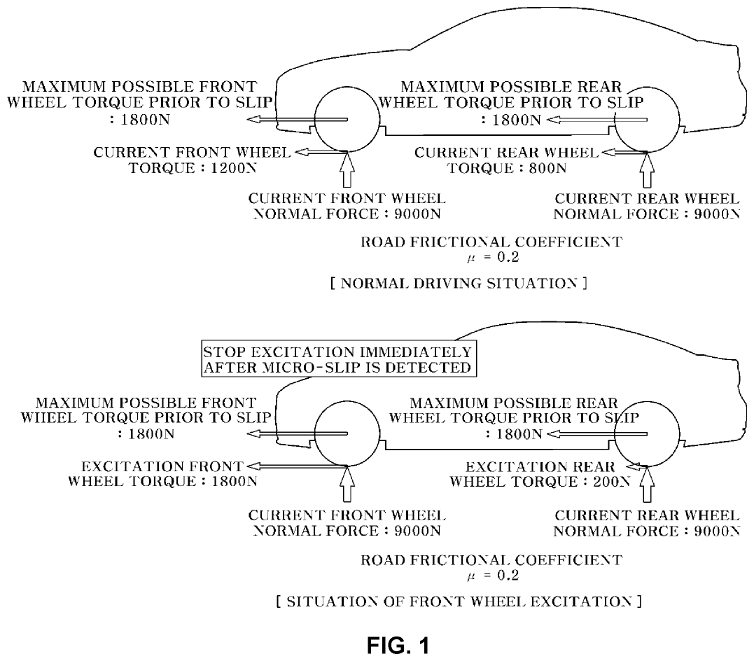

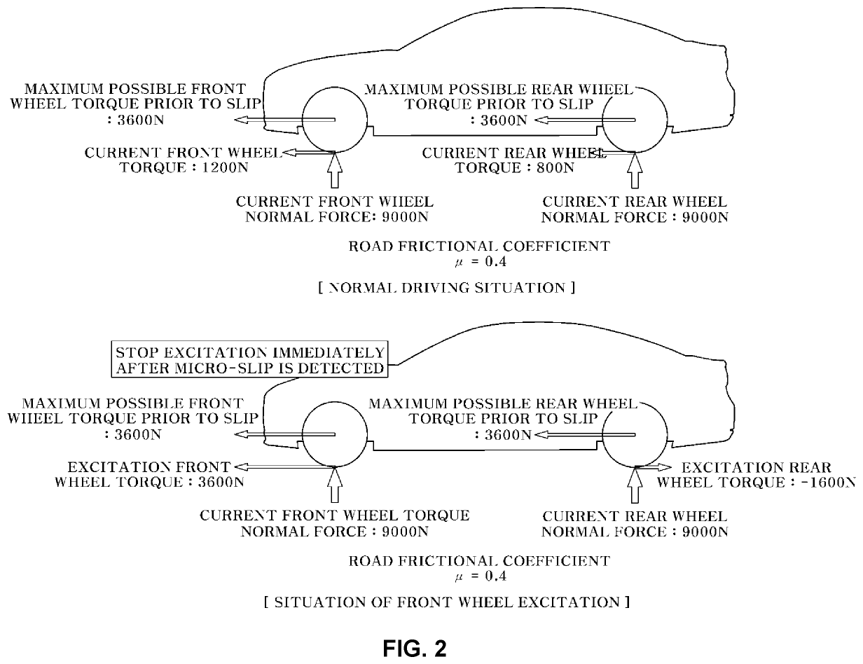

FIGS. 1 and 2 are diagrams for explaining a principle and method of estimating a road frictional coefficient according to the present disclosure and illustrate an example of a 4WD vehicle for independently applying controlled torque to the front wheel and the rear wheel.

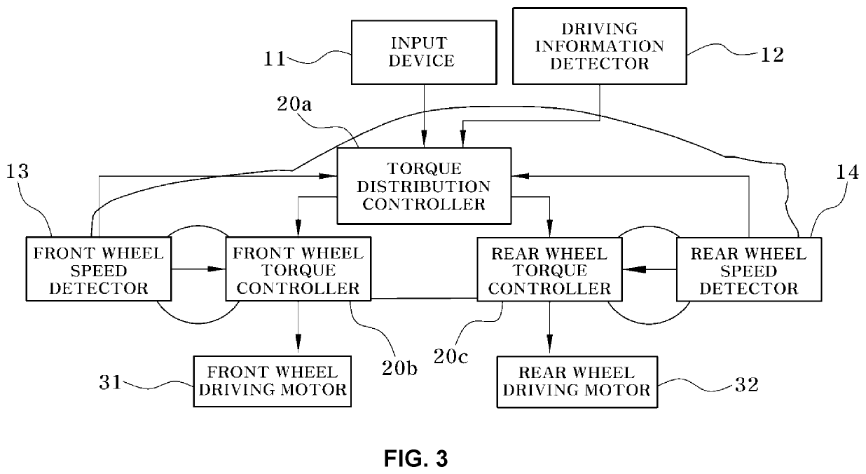

In detail, according to the present disclosure, a control target vehicle may be an e-4WD vehicle for independently applying driving torque to the front wheel and the rear wheel, respectively, and for applying regenerative torque to at least one of the front wheel and the rear wheel, and in detail, may be an e-4WD vehicle including a front wheel driving motor 31 and a rear wheel driving motor 32 (shown in FIG. 3) installed therein to independently apply driving torque and regenerative torque to the front wheel and the rear wheel, respectively.

Hereinafter, the vehicle wheel may refer to each of the front wheel, the rear wheel, the front wheel, and the rear wheel, the front wheel torque may refer to torque applied to the front wheel by the front wheel driving motor 31, and the rear wheel torque may refer to torque applied to the rear wheel by the rear wheel driving motor 32.

Here, the torque may be driving torque or regenerative torque, and the driving torque may be defined as positive (+) torque, and the regenerative torque may be defined as negative (−) torque.

Hereinafter, the front wheel driving torque or the front wheel regenerative torque may refer to driving torque or regenerative torque applied to the front wheel by the driving device 31, and the rear wheel driving torque or the rear wheel regenerative torque may refer to driving torque or regenerative torque applied to the rear wheel by the driving motor 32.

The e-4WD vehicle may independently control torque applied to the front wheel and torque applied to the rear wheel according to the characteristics of the e-4WD vehicle, and thus, a numerous number of front and rear wheel torque distribution combinations may be generated for the same acceleration and deceleration of the vehicle.

That is, there may be a numerous number of combinations of the front and rear wheel torque and the rear wheel torque, which satisfy required torque for driving a vehicle, and in this case, among the combinations of the front and rear wheel torque and the rear wheel torque, which satisfy the required torque, both the front wheel torque and the rear wheel torque are driving torque (which may be required torque for acceleration of the vehicle), one of the front wheel torque and the rear wheel torque may be driving torque and the other one may be regenerative torque (the required torque may be for acceleration or deceleration of the vehicle), or both the front wheel torque and the rear wheel torque may be regenerative torque (which may be required torque for deceleration of the vehicle).

In this case, when both the front wheel torque and the rear wheel torque are driving torque for acceleration of the vehicle, if the rear wheel torque needs to be reduced when the front wheel torque is increased, the sum of the front wheel torque and the rear wheel torque may satisfy the required torque, and if the front wheel torque needs to be reduced when the rear wheel torque is increased, the sum of the front wheel torque and the rear wheel torque may satisfy the required torque.

When one of the front wheel torque and the rear wheel torque is positive (+) driving torque and the other one is negative (−) torque (which may be a vehicle acceleration or a vehicle deceleration), both the driving torque and the regenerative torque need to be increased based on an absolute value thereof.

When the driving torque is increased, the regenerative torque needs to be reduced in a negative direction (a reference of an absolute value of the regenerative torque is increased, and as such, in order to increase driving torque of any one of the front wheel and the rear wheel, regenerative torque may be applied to the other one.

When both the front wheel torque and the rear wheel torque for deceleration of the vehicle are regenerative torque, if the rear wheel torque needs to be reduced based on an absolute value thereof when the front wheel torque is increased based on an absolute value thereof, the sum of the front wheel torque and the rear wheel torque may satisfy the required torque, and when the front wheel torque needs to be reduced based on an absolute value thereof when the rear wheel torque is increased based on an absolute value thereof, the required torque may be satisfied.

In a general motor driven vehicle, regenerative torque is negative (−) torque, and thus, in the specification, an increase in regenerative torque, and an increase in regenerative torque in a negative (−) direction may refer to an increase in an absolute value of the regenerative torque, and increase in the regenerative torque may refer to an increase in braking force applied to a corresponding vehicle wheel.

Hereinafter, reduction in regenerative torque refers to reduction in an absolute value of regenerative torque, and indicates that negative (−) torque is gradually and further increased toward 0.

As a result, like in an e-4WD vehicle, as described above, there may be various combinations of the front wheel torque and the rear wheel torque which satisfy the required torque, and front and rear wheel torque distribution control that satisfy the required torque may be performed in various ways, and thus even if the front wheel torque and the rear wheel torque are continuously changed, acceleration and deceleration intent of a driver may be applied in real time, and simultaneously required torque may be always satisfied.

When one torque of the front wheel and the rear wheel is increased, slip may occur at an arbitrary time point depending on a driving road, a frictional coefficient of a road surface may be estimated using a torque value of the vehicle wheel and normal force of the vehicle wheel at a time point when slip occurs (or at a time point when equivalent inertia is changed).

As such, according to the present disclosure, while the front and rear wheel torque distribution control is performed in such a way that the sum of the front wheel torque and the rear wheel torque always follows required torque by the front wheel driving device and the rear wheel driving device, the front wheel torque and the rear wheel torque may be continuously changed to estimate a frictional coefficient of a road surface, and slip or equivalent inertia changed during control of the front wheel torque and the rear wheel torque may be detected to estimate a road frictional coefficient.

According to the present disclosure, the equivalent inertia change may be detected for each of a front wheel driving system and a rear wheel driving system, and when the equivalent inertia is changed, this means that slip occurs in the corresponding vehicle wheel.

Thus, detection of the equivalent inertia change may be understood as detection of slip, and according to the present disclosure, detection of the equivalent inertia change may be understood as being included in the scope of detection of slip.

In detail, according to the present disclosure, a procedure of estimating a road frictional coefficient may be consistently performed when a vehicle travels at a constant speed or may be intermittently performed at a predetermined period.

Thus, a road state in which a vehicle automatically controls torque applied to each vehicle wheel may be previously estimated and recognized compared with a road state (i.e., a road frictional coefficient) in which an actual driver of the vehicle shows deceleration intent.

Before a driver feels the necessity of excessive deceleration or turning compared with a road state, the vehicle may automatically estimate the road state and then, if necessary, the vehicle may be previously and forcibly decelerated based on the estimated road state, and thus risk may be more safely and obviously avoided.

According to the present disclosure, the front wheel torque and the rear wheel torque may be controlled to estimate a road state in a different way from a general vehicle, and if necessary, the vehicle may also be forcibly decelerated different from user's intent depending on the road state for driving safety, and thus, the driver may experience a sense of unfamiliarity.

Thus, logic may be set to operate the road state estimation and the vehicle deceleration control according to the present disclosure only when a driver selects control mode-on through an input device in the vehicle.

Hereinafter, while torque (driving torque or regenerative torque) applied to any one of the front wheel and the rear wheel is increased, torque applied to the other one is controlled to satisfy required torque in order to estimate a road state, that is, in order to estimate a road frictional coefficient, which will be referred to as ‘torque excitation’.

According to the present disclosure, an operation of increasing the front wheel torque and simultaneously controlling (reduction in rear wheel driving torque or increase in rear wheel regenerative torque) rear wheel torque in such a way that the sum of the front wheel torque and the rear wheel torque follows required torque will be referred to as ‘front wheel excitation’.

In contrast, according to the present disclosure, an operation of increasing the rear wheel torque and simultaneously controlling (reduction in front wheel driving torque or increase in the front wheel regenerative torque) front wheel torque in such a way that the sum of the front wheel torque and the rear wheel torque follows the required torque will be referred to as ‘rear wheel excitation’.

According to the present disclosure, the torque excitation may be considered as a kind of torque blending of continuously changing the front wheel torque and the rear wheel torque while sum of the front wheel torque and the rear wheel torque follows the required torque.

According to the present disclosure, the torque excitation refers to adjustment of the front wheel torque and the rear wheel torque in a reverse direction, in which case the reverse-direction adjustment includes the case in which the front wheel increases the driving torque but the rear wheel reduces the driving torque that is the same-direction torque and the case in which the rear wheel increases the driving torque but the front wheel reduces the driving torque.

The reverse-direction adjustment may include the case in which the front wheel increases the driving torque but the rear wheel increases regenerative torque that is reverse-direction torque, and the case in which the rear wheel increases the driving torque but the front wheel increases regenerative torque that is reverse-direction torque.

The reverse-direction adjustment may include the case in which the front wheel increases regenerative torque but the rear wheel reduces regenerative torque that is the same-direction torque.

In addition, any case may correspond to the torque excitation according to the present disclosure as long as, while torque of one of the front wheel and the rear wheel is artificially increased to estimate a road frictional coefficient, the other one torque is adjusted to follow required torque.

According to the present disclosure, a road frictional coefficient (road state) with which a front wheel is grounded may be estimated using front wheel torque and front wheel normal force at a time point of detecting front wheel slip and a time point detecting the equivalent inertia change.

According to the present disclosure, the road frictional coefficient with which the rear wheel is grounded may be estimated using front wheel torque and front wheel normal force at a time point of detecting rear wheel slip and a time point of detecting equivalent inertia change while the rear wheel excitation is performed.

For example, an upper side of FIG. 1 illustrates an example of a normal driving situation of a vehicle, and a lower side of FIG. 1 illustrates an example of a front wheel excitation situation.

In the drawing, the two situations have the same required torque of 2,000 Nm, the front wheel and the rear wheel in the two situations may have the same normal force of 9,000 N, and maximum possible front wheel torque prior to slip and maximum possible rear wheel torque prior to slip in the two situations are the same value of 1,800 Nm.

Here, when the maximum possible front wheel torque prior to slip and the maximum possible rear wheel torque prior to slip are 1,800 Nm, this means that slip is detected on the corresponding vehicle wheel when the front wheel torque or the rear wheel torque is increased to 1,800 Nm.

The normal driving situation exemplified in FIG. 1 may have current front wheel torque of 1,200 Nm and current rear wheel torque of 800 Nm, in which case the sum of the front wheel torque and the rear wheel torque satisfies required torque of 2,000 Nm.

The normal driving situation exemplified in FIG. 1 may have the current front wheel normal force and the current rear wheel normal force that are 9,000 N.

FIG. 1 illustrates an example in which front wheel excitation is performed, and in the front wheel excitation situation of FIG. 1, driving torque may be applied to both the front wheel and the rear wheel.

In the front wheel excitation situation of FIG. 1, the front wheel torque (front wheel driving torque) may be linearly and continuously increased with a predetermined inclination, in which case the rear wheel torque may be reduced with the same inclination to satisfy required torque of 2,000 Nm.

When the front wheel torque is increased to become the same as the maximum possible front wheel torque (1,800 Nm) prior to slip, micro-slip at the front wheel may be detected, and in this case, a road frictional coefficient (e.g., μ=0.2) may be estimated from front wheel torque (1,800 Nm) and front wheel normal force (9,000 N).

As such, in the front wheel excitation situation of FIG. 1, driving torque applied to the front wheel by the front wheel driving device may be gradually increased up to the time point of detecting slip or the time point of detecting equivalent inertia, and simultaneously, driving torque (rear wheel driving torque=required torque−front wheel driving torque) applied to the rear wheel by the rear wheel driving device may be gradually reduced to satisfy the required torque.

As another example, an upper side of FIG. 2 illustrates an example of a normal driving situation of a vehicle, and a lower side of FIG. 2 illustrates an example of a front wheel excitation situation.

In the drawing, the two situations have the same required torque of 2,000 Nm, the front wheel and the rear wheel in the two situations may have the same normal force of 9,000 N, and maximum possible front wheel torque prior to slip and maximum possible rear wheel torque prior to slip in the two situations are the same value of 3,600 Nm.

Here, when the maximum possible front wheel torque prior to slip and the maximum possible rear wheel torque prior to slip are 3,600 Nm, this means that slip is detected on the corresponding vehicle wheel when the front wheel torque or the rear wheel torque is increased to 3,600 Nm.

The normal driving situation exemplified in FIG. 2 may have current front wheel torque of 1,200 Nm and current rear wheel torque of 800 Nm, in which case the sum of the front wheel torque and the rear wheel torque satisfies required torque of 2,000 Nm.

In the normal driving situation exemplified in FIG. 2, both the current front wheel normal force and the current rear wheel normal force are 9,000 N.

FIG. 2 also illustrates an example of a front wheel excitation situation, and in the front wheel excitation situation of FIG. 2, positive (+) driving torque is applied to the front wheel, and negative (−) regenerative torque is applied to the rear wheel.

In the front wheel excitation situation of FIG. 2, the front wheel torque (front wheel driving torque) may be linearly and continuously increased with a predetermined inclination, in which case the rear wheel torque may be increased with the same inclination to satisfy required torque of 2,000 Nm.

Here, an increase in regenerative torque refers to an increase in an absolute value of the torque, which means that regenerative torque is reduced in a negative direction.

When the front wheel torque is increased to become the same as the maximum possible front wheel torque (3,600 Nm) prior to slip, micro-slip at the front wheel may be detected, and in this case, a road frictional coefficient (e.g., μ=0.4) may be estimated from front wheel torque (3,600 Nm) and front wheel normal force (9,000 N).

As such, in the front wheel excitation situation of FIG. 2, driving torque applied to the front wheel by the front wheel driving device may be gradually increased up to the time point of detecting slip or the time point of detecting equivalent inertia, and simultaneously, the rear wheel driving device may apply regenerative torque that is gradually increased to the rear wheel to satisfy the required torque.

According to the present disclosure, like in the examples of FIGS. 1 and 2, when the vehicle travels at a constant speed with predetermined required torque, front wheel excitation or rear wheel excitation may be performed to estimate a road frictional coefficient, in which case driving torque is applied to both the front wheel and the rear wheel, or driving torque is applied to any one of the front wheel and the rear wheel and regenerative torque is applied to the other one.

Like in the example of FIG. 2, during the front wheel excitation procedure, even if front wheel driving torque that is positive torque is increased to required torque or greater, when slip or equivalent inertia change at the front wheel is not detected, front wheel driving torque may be further increased to required torque or greater, in which case, regenerative torque is applied to the rear wheel to satisfy the required torque.

Similarly, during the rear wheel excitation procedure, even if rear wheel driving torque that is positive torque is increased to required torque or greater, when slip or equivalent inertia change at the rear wheel is not detected, rear wheel driving torque may be further increased to required torque or greater, in which case, regenerative torque is applied to the front wheel to satisfy the required torque.

FIG. 3 is a diagram illustrating the configuration of a control system for estimating a road frictional coefficient and controlling driving of a vehicle according to the present disclosure. As shown in the drawing, the control system may include a torque distribution controller 20a for performing torque distribution control on the front wheel and the rear wheel to satisfy required torque for driving the vehicle.

Here, the required torque may be determined based on driving information detected and collected by a driving information detector 12 in the vehicle, and the driving information may include information on an accelerator pedal manipulation state of a driver, that is, driver accelerator pedal input information.

The driver accelerator pedal input information may be accelerator pedal position (i.e., pedal depth) detected by an accelerator position sensor (APS).

In the specification, driving information collected from the vehicle in order to determine required torque, and a procedure or method of determining required torque from the driving information are known technologies, and thus a detailed description will be omitted.

The torque distribution controller 20a may distribute front wheel torque and rear wheel torque in such a way that the sum of the front wheel torque and the rear wheel torque satisfies the required torque and may generate and output a torque command corresponding to the distributed front wheel torque and rear wheel torque, that is, a front wheel torque command a rear wheel torque command.

The control system may include a front wheel torque controller 20b for controlling an operation of the front wheel driving motor 31 to apply torque corresponding to a front wheel torque command transferred from the torque distribution controller 20a that is a high-ranking controller to the front wheel, and a rear wheel torque controller 20c for controlling an operation of the rear wheel driving motor 32 to apply torque corresponding to a rear wheel torque command transferred from the torque distribution controller 20a to the rear wheel.

Here, the torque may be driving torque or regenerative torque.

A driving or regenerative operation of the front wheel driving motor 31 may be controlled by the front wheel torque controller 20b to generate and output torque corresponding to a front wheel torque command and to apply the torque to the front wheel, and a driving or regenerative operation of the rear wheel driving motor 32 may be controlled by the rear wheel torque controller 20c to generate and output torque corresponding to a rear wheel torque command and to apply the torque to the rear wheel.

Accordingly, distribution of the front wheel torque and the rear wheel torque may be performed to satisfy required torque required while the vehicle travels.

As described above, the front wheel torque controller 20b and the rear wheel torque controller 20c may be separate controllers for respective vehicle wheels that control torque applied to the front wheel and the rear wheel by controlling the driving or regenerative operation of each driving device.

A front wheel speed detector 13 and a rear wheel speed detector 14 may be used to detect a rotation speed (wheel speed) of the front wheel and the rear wheel that are a driving wheel, and may be a general a wheel-speed sensor for detecting the rotation speed of the corresponding vehicle wheel or a driving axis.

According to the present disclosure, the front wheel speed and the rear wheel speed that are detected by the front wheel speed detector 13 and the rear wheel speed detector 14, respectively, may be input to the torque distribution controller 20a that is a high-ranking controller, and in addition, speed information of the corresponding vehicle wheel, which is detected in real time, may also be input to the front wheel torque controller 20b and the rear wheel torque controller 20c.

According to the present disclosure, the front wheel speed and the rear wheel speed may be used to calculate the vehicle speed, and may be used to detect slip of the corresponding vehicle wheel using the calculated vehicle speed as a reference speed.

According to the present disclosure, the front wheel speed and the rear wheel speed may be used to acquire information of respective speeds of the corresponding vehicle wheel and the driving axis, and information on a speed of each vehicle wheel may be used to detect an equivalent inertia change along with torque information of the corresponding vehicle wheel.

According to the present disclosure, the torque distribution controller 20a may be a general vehicle controller or hybrid controller that is a high-ranking controller in a motor driven vehicle and an electric motored freight car, and the front wheel torque controller 20b and the rear wheel torque controller 20c may be a general motor controller for controlling an operation of each driving motor under cooperative control with the high-ranking controller.

As such, the driving control procedure according to the present disclosure may be performed by a plurality of controllers that perform cooperative control, but may be performed by one integrated control device, and hereinafter, the plurality of controllers and the one integrated control device may be collectively referred to as a controller.

Hereinafter, the road frictional coefficient estimating procedure and the driving control procedure of the vehicle according to the present disclosure will be described based on sequential operations in detail.

First, according to the present disclosure, unlike in a general vehicle, artificial torque excitation for continuously changing the front wheel torque and the rear wheel torque may be performed to estimate a road frictional coefficient, and if necessary, the vehicle may be forcibly decelerated unlike driver's intent for driving safety depending on the estimated road frictional coefficient, and thus, the driver may experience a sense of unfamiliarity of the vehicle behavior.

When the torque excitation is performed, the driver may not recognize change in front and rear wheel torque if possible, but the driver may recognize a change in torque due to an unintended vehicle behavior, and thus the torque excitation may be required only when the driver selects artificial torque excitation and forcible deceleration control of the vehicle of the vehicle or when a current mode is a snow mode.

Estimation of the road frictional coefficient through torque excitation requires artificial reverse-direction adjustment of torque between the front wheel and the rear wheel, and thus there may be a limit to always apply the reverse-direction adjustment in terms of efficiency.

Thus, control logic may be set to operate road state estimation and vehicle deceleration control according to the present disclosure only when the driver selects a control mode on or a current state if a snow mode on through an input device 11 in the vehicle.

Here, the control mode refers to a driving control mode according to the present disclosure differently from the snow mode, and the control mode on means that a driver turns on the driving control mode according to the present disclosure through the input device 11 to perform the driving control mode according to the present disclosure that will be described below.

The driving control mode according to the present disclosure may include a mode including torque excitation and estimation of road frictional coefficient using the same, and vehicle deceleration control based on the estimated road frictional coefficient.

As such, the driving control procedure according to the present disclosure may be selectively performed only when a driver turns on a control mode or turns on a snow mode.

Then, in the case of the control mode on or the snow mode on, when the driving control procedure according to the present disclosure is started, it may be determined whether a condition for performing excitation is satisfied.

When the vehicle suddenly accelerates or suddenly decelerates, it may be possible to estimate the road frictional coefficient using vehicle dynamic approach in the current situation without artificial torque excitation.

Thus, the case in which actual artificial excitation is required may be the case in which the vehicle travels at a constant speed in a situation in which the driver insufficiently recognizes the road frictional coefficient.

Thus, in the present operation, the controller may determine whether the vehicle travels at a constant speed and a constant-speed driving behavior is performed may be determined from driving information detected and collected by the driving information detector 12 in the vehicle, and when the vehicle indicates the constant-speed driving behavior state, a condition for performing excitation may be determined to be satisfied.

According to an embodiment of the present disclosure, driving information for determining the condition for performing excitation may include driver accelerator pedal input information, brake pedal input information, generated torque (currently generated driving device torque or current front and rear wheel torques), vehicle inertia, and driver steering input information.

Here, the driver accelerator pedal input value may be detected by an accelerator pedal sensor (APS), the driver brake pedal input value may be detected by a brake pedal sensor (BPS), and the vehicle inertia may be detected by an inertia sensor installed in the vehicle.

The driver steering input value may correspond to a steering angle indicating a driver steering wheel manipulation state, which may be detected by a steering angle sensor.

According to the present disclosure, when the accelerator pedal input value, the brake pedal input value, the generated torque (required torque or front and rear wheel torques), the vehicle inertia, and the driver steering input value fall within predetermined setting ranges, respectively, the controller may be configured to determine that the vehicle is in the constant-speed driving behavior state to satisfy the condition for performing excitation.

In addition, as one of the condition for performing excitation, a time repetition condition may also be considered.

This may be applied to alleviate a problem in terms of degradation in driving efficiency, and in this regard, excitation may be intermittently and repeatedly performed with a predetermined period without continuous excitation on all torque regions and time.

As such, when the driving information related condition is satisfied and a time for performing excitation with a predetermined period is also reached, the controller may determine that the condition for performing excitation is satisfied.

Then, when the condition for performing excitation is satisfied, the controller may determine a direction of output torque (required torque) for vehicle behavior at a time when excitation is started, and in this case, the output torque is obtained via sum of torque output from the front wheel driving motor 31 and torque output from the rear wheel driving motor 32, which may be required torque according to driver's intent, and a direction of the output torque may refer to a direction of required torque according to driver's intent.

As such, the direction of the output torque summed to determine a distribution amount of torque for the torque excitation may be determined, which is a procedure of determining whether the driver currently intends to accelerate or decelerate the vehicle.

According to driver's intent of acceleration and deceleration and an excitation strategy to be used, whether torque between the front wheel and the rear wheel is alternately reduced or increased may be determined.

The controller may compare the front wheel torque and the rear wheel torque.

According to the present disclosure, a main driving wheel prior to excitation may also be used as a main driving wheel during excitation, and to this end, amplitudes of the front wheel torque and the rear wheel torque may be compared with each other.

For example, in an e-4WD vehicle, both a front wheel and a rear wheel correspond to driving wheels, and when driver's intent of acceleration is determined from accelerator pedal input information, the controller may compare the front wheel torque (which is driving torque) and the rear wheel torque (which is driving torque) and may determine a driving wheel with large torque as a main driving wheel.

In this case, when a front wheel is a main driving wheel, the controller may further increase front wheel torque during excitation and simultaneously may reduce rear wheel torque or may apply regenerative torque to a rear wheel.

In contrast, when rear wheel torque prior to excitation is larger than rear wheel torque during excitation, the controller may further increase the rear wheel torque during excitation and simultaneously may reduce front wheel torque or may apply regenerative torque to the front wheel.

Needless to say, control of torque applied to the front wheel and the rear wheel refers to control of torque output from the front wheel driving motor 31 and the rear wheel driving motor 32, which is performed by controlling an operation of the front wheel driving motor 31 and the rear wheel driving motor 32 by the controller.

According to the present disclosure, a strategy for performing torque excitation for estimation of a road frictional coefficient may be classified into 1) a strategy for maintaining a main driving wheel prior to excitation, 2) a strategy for preventing rear wheel slip (oversteer), and 3) a strategy for minimizing an estimated time.

The strategy 1) may be a strategy for maximizing a torque distribution strategy performed prior to excitation to the maximum, may increase driving force (i.e., driving torque) of a main driving wheel while a vehicle is driven, and may increase braking force (i.e., regenerative torque) of a front wheel while the vehicle brakes.

Through this strategy, existing performance and distribution strategy of the vehicle may be maintained to the maximum.

The strategy 2) may prevent slip of a rear wheel to the maximum for safety, and may correspond to a method performed in terms of only a front wheel for estimation of a road frictional coefficient based on excitation.

In this case, torque excitation may be performed to increase the amplitude of front wheel driving force (i.e., front wheel driving torque) and to reduce the amplitude of rear wheel driving force (i.e., rear wheel driving torque) during acceleration.

Torque excitation may be performed to increase the amplitude of front wheel braking force and to reduce the amplitude of rear wheel braking force during deceleration.

Here, an increase in front wheel braking force refers to an increase in regenerative torque, which means that regenerative torque is increased in a negative direction and that an absolute value of regenerative torque is increased.

The strategy 3) may be a method of causing slip within a shortest time in a low torque region as possible to estimate a road frictional coefficient.

To this end, it may be advantageous that slip is caused in a driving wheel with a small normal force as possible, and thus the front wheel normal force and the rear wheel normal force may be compared, and when the front wheel normal force is smaller than the rear wheel normal force, front wheel driving force may be increased during acceleration, and front wheel braking force may be increased during deceleration.

In contrast, when the rear wheel normal force is smaller than the front wheel normal force, rear wheel driving force during acceleration may be increased, and rear wheel braking force during deceleration may be increased.

In the specification, the method of calculating front wheel normal force and rear wheel normal force of a vehicle and procedures thereof are known technologies, and thus a detailed description will be omitted.

Then, the controller may determine a variation range of front wheel torque and rear wheel torque for excitation.

The front wheel torque and the rear wheel torque may be corrected in opposite directions in such a way that the sum of the front wheel torque and the rear wheel torque always satisfies the required torque required while the vehicle is driven during torque excitation.

In this case, torque variation directions at the front wheel and the rear wheel are different from each other, but the front wheel and the rear wheel may have the same amplitude of torque variation (based on a wheel).

In order to estimate a maximum frictional coefficient of a road region with high friction, the amplitude of torque variation needs to be high, but when a target for estimating a road frictional coefficient is limited to a region with a low frictional coefficient, it may not be required to increase the amplitude of required variation.

Thus, according to the present disclosure, the target for estimating the road frictional coefficient may be limited to the region with a low frictional coefficient.

As such, the target for estimating the road frictional coefficient is limited to the region with a low frictional coefficient due to the following causes.

1) In order to estimate a region with a high frictional coefficient, the amplitude of the excitation torque variation range needs to be increased. In this regard, in a torque blending phase, i.e., in a transient state in which torque of one of the front wheel and the rear wheel is increased and the other one is reduced for torque excitation, a sense of unfamiliarity of a vehicle behavior may be generated.

2) While torque is adjusted in opposite directions between the front wheel and the rear wheel, recirculation of power may occur to degrade efficiency, and when excitation torque variation range is increased, a reduction range of driving efficiency may be increased.

3) When the front wheel driving motor and the rear wheel driving motor are different in capacity due to hardware properties, the excitation torque variation range needs to be limited to output of a motor with small capacity.

With regard to a reference for limiting the excitation torque variation range, a maximum torque variation range during excitation may be pre-set to a fixed constant value.

In order to prevent degradation in efficiency, driving force between the front wheel and the rear wheel and an excitation torque variation range in a region without recirculation of power may be determined and used, or the excitation torque variation range may be limited based on the amount of recirculation (redundant output/amplitude of redundant torque, etc.).

Then, as an operation of performing actual torque excitation by the controller, the controller may actually correct the front wheel torque and the rear wheel torque (torque of two driving axes) in opposite directions.

According to the aforementioned excitation strategy, from the front wheel and the rear wheel, torque applied to a driving wheel at which torque needs to be increased may be actually increased, and torque applied to a driving wheel at which torque needs to be reduced may be actually reduced.

This may be gradually performed until slip is detected, or may be gradually performed until an equivalent inertia change is detected.

In this case, in order to maintain the sum of the front wheel torque and the rear wheel torque to torque prior to excitation, the sum of torque before excitation is started and the sum of torque after excitation is started may have no difference while required torque is satisfied by the sum of the front wheel torque and the rear wheel torque.

To this end, an increase amount of torque of one of the front wheel and the rear wheel and a reduction amount of torque of the other one may be monitored, and torque control may be performed to equalize the increase amount of torque and the reduction amount of torque.

This procedure may be performed every sample time, and torque variation range or torque variation inclination to be adjustable every sample time may be limited using a torque limiter or the like.

In this case, the sum of torque of the front wheel and torque of the rear wheel that are corrected via torque excitation needs to be equalized to the sum of torque prior to excitation.

Then, the controller may detect slip while the above torque excitation is performed.

As torque excitation is performed a torque difference between the front wheel and the rear wheel (between driving axes of the front wheel and the rear wheel) is increased, a condition in which slip of a specific vehicle wheel more easily occurs may be formed.

Torque excitation needs to be further performed every sample time, and in this case, slip needs to be detected every sample time, and detection of slip may be performed through the following procedures.

When the vehicle is driven, speeds of respective vehicle wheel may be converted into vehicle speeds, a lowest value of the wheel speeds may be based, and a vehicle wheel having a positive (+) difference from the lowest value may be determined as slip.

Similarly, when the vehicle brakes, speeds of respective vehicle wheel may be converted into vehicle speeds, a highest value of the wheel speeds may be based, and a vehicle wheel having a negative (−) difference from the highest value may be determined as slip.

A reference for differentiation between driving and braking may be set as a direction or a function of the sum of the front wheel torque and the rear wheel torque.

Motor speed-based slip may also be detected instead of detection of slip based on vehicle wheel speed (wheel speed).

It may also be possible to determine whether slip occurs based on equivalent inertia variation of each axle/vehicle wheel based on an equivalent inertia monitor.

The method of determining the equivalent inertia variation is disclosed in Korean Patent Application No. 10-2019-0092527 (filed Jul. 30, 2019), Korean Patent Application No. 10-2019-0096432 (filed Aug. 8, 2019), Korean Patent Application No. 10-2019-0096433 (filed Aug. 8, 2019), Korean Patent Application No. 10-2019-0095953 (filed Aug.7, 2019), and Korean Patent Application No. 10-2019-0092528 (filed Jul. 30, 2019), which are owned by the Applicants and the inventor of the present application, and is a known technology, and thus a detailed description thereof is omitted.

As described above, when slip is detected while torque excitation is performed, the controller may immediately stop the torque excitation and may not increase a torque difference between front and rear wheels and between axles any longer.

Driving force control may be performed to follow a torque command before the torque excitation is immediately performed.

As such, in a procedure of converting to a torque command prior to torque excitation from a torque command during torque excitation, a change in the torque command may be controlled by applying a rate limiter or a filter.

Then, when slip is detected or an equivalent inertia change is detected, the controller may stop torque excitation as described above, and may estimate and determine the road frictional coefficient.

In this case, at a time point of detecting the slip or the equivalent inertia change, the controller may record information on torque applied to a driving axis and a vehicle wheel (driving wheel) at which the slip or the equivalent inertia change is detected.

Normal force information of the vehicle wheel at which the slip or the equivalent inertia change is detected at the same time may be recorded, and estimation of normal force may use a known technology.

Then, the controller may determine the current road frictional coefficient using setting data from torque applied to the vehicle wheel at which the slip or the equivalent inertia change is detected and normal force information at the vehicle wheel.

Here, the setting data may be data for defining a correlation between torque and normal force, and a frictional coefficient, and the data may be previously input and stored and then may be used to determine a frictional coefficient from the torque and the normal force.

Here, the setting data may be data obtained by defining a frictional coefficient as a function of torque and normal force, and in detail, may be a map (which is a map for setting a frictional coefficient using a value based on torque and normal force) configured to determine a frictional coefficient using torque and normal force as input, a mathematical expression for calculating a frictional coefficient using a function of torque or normal force, or the like.

Generally, a torque value and a road frictional coefficient may have a linearly and proportional relationship on a normal force value, and the normal force value and the road frictional coefficient may have a linearly and inverse-proportional relationship on the same torque value.

Then, as described above, when the road frictional coefficient is determined, the controller may control driving of the vehicle based on the road frictional coefficient and, in this case, automatic deceleration for forcibly decelerating the vehicle may be performed based on the road frictional coefficient.

The controller may control a warning operation of warning a driver about safe driving according to the estimated road frictional coefficient, and in this case, may warn the driver about safe driving using a warning device such as a display or speaker in the vehicle.

The driver may select whether only warning is performed or whether both warning and automatic deceleration are performed using the input device 11.

The controller may pre-set a target speed while the vehicle decelerates as a value based on a road frictional coefficient using a map, a table, or a mathematical expression, and thus, when a target speed corresponding to the estimated road frictional coefficient is determined, the controller may control the vehicle speed to the target speed.

The target speed determined according to a road frictional coefficient may be used as a speed limit during vehicle deceleration control, and thus as a road frictional coefficient in the map, the table, or the mathematical expression is lowered, a target speed (speed limit) or a low value may be set.

Determination and distribution of deceleration torque while the vehicle decelerates needs to be performed within a deceleration torque range allowed by the currently estimated road frictional coefficient.

When the current speed is lower than target speed, i.e., speed limit determined from the road frictional coefficient, deceleration control may not be performed, and thus, the target speed may be used only for limiting a speed.

A procedure of converting torque excitation into a torque command prior to torque excitation in the torque command for performing torque excitation may be omitted if necessary, and in the automatic deceleration torque command may be immediately converted from the torque command for performing torque excitation.

The torque command for automatic deceleration and the torque command according to driver's intent may conflict with each other, and thus automatic deceleration control may not be performed according to driver's selection or settings and may follow driver's intent.

Alternatively, driver's intent may be disregarded and automatic deceleration control may be performed, or a final torque command may be calculated using a method of multiplying a pre-set weight to each torque command and summing the result values in simultaneous consideration of a torque command for automatic deceleration control and a torque command for driver's intent, and distribution of front and rear wheel torque and control of torque output may be performed according to the calculated torque command.

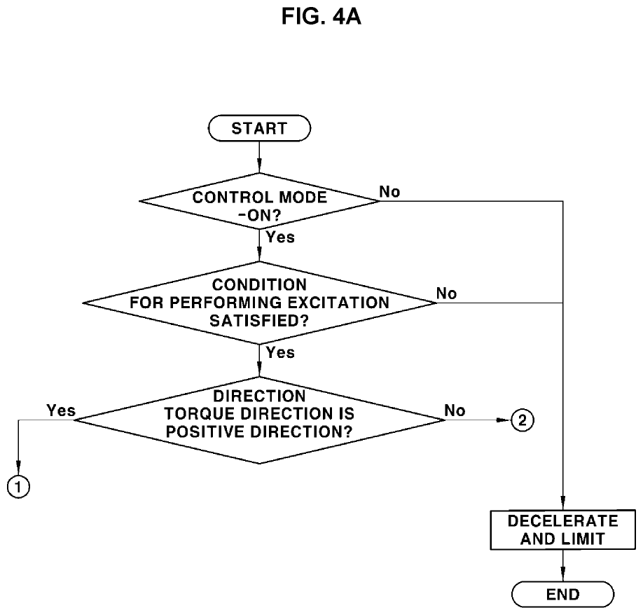

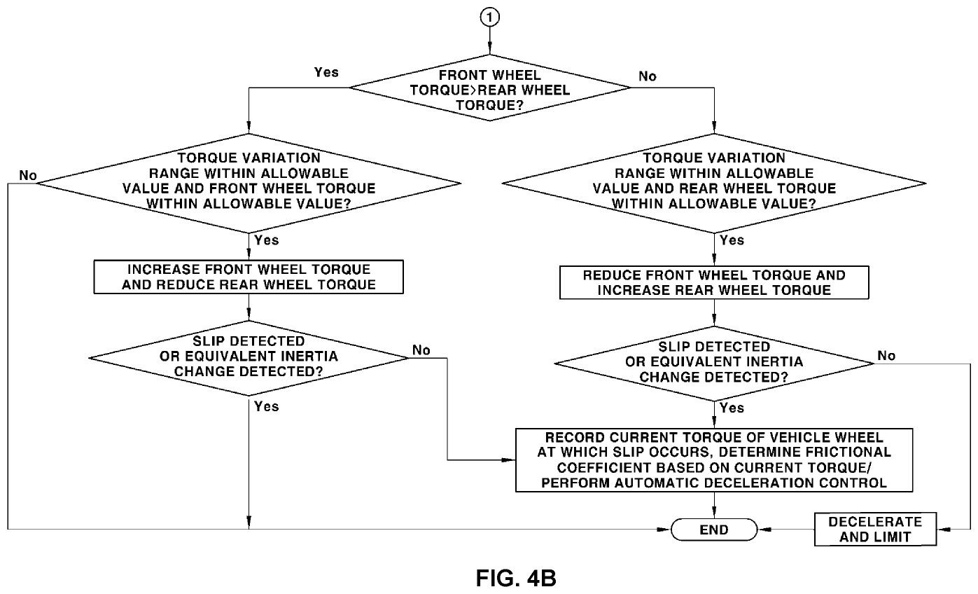

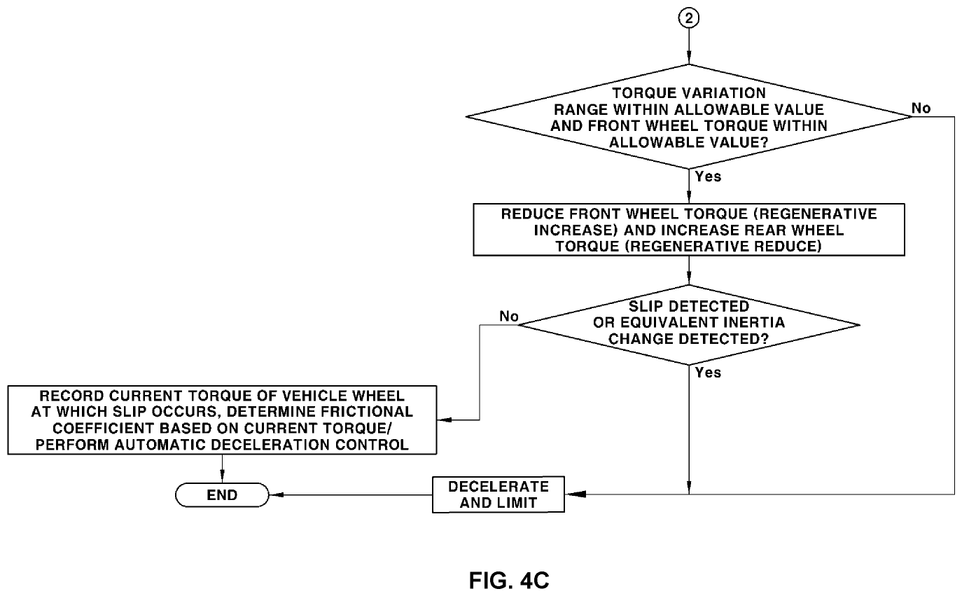

FIGS. 4 to 6 are flowcharts showing estimation of a road frictional coefficient and control of driving of a vehicle according to the present disclosure and illustrate different embodiments that are different according to the aforementioned strategy for performing torque excitation.

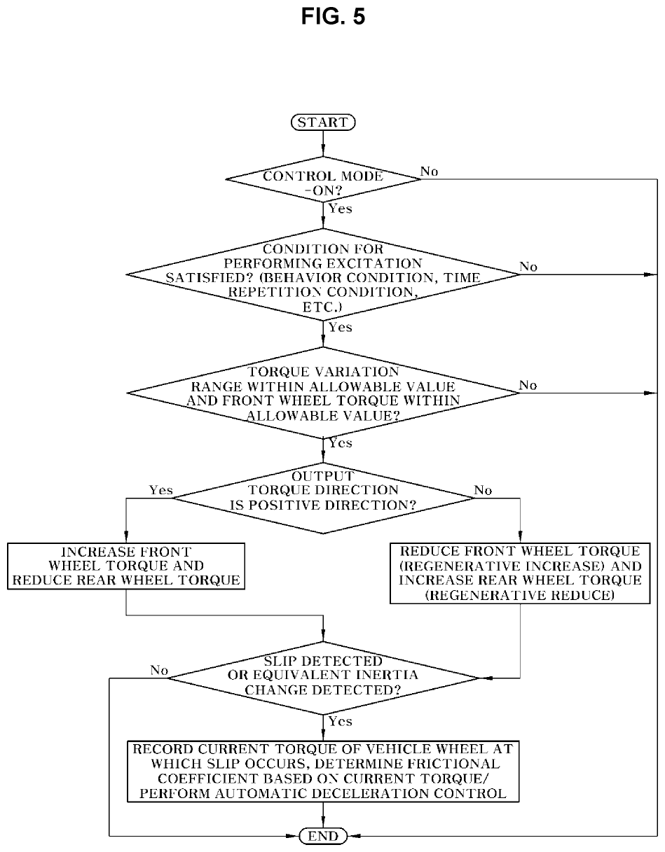

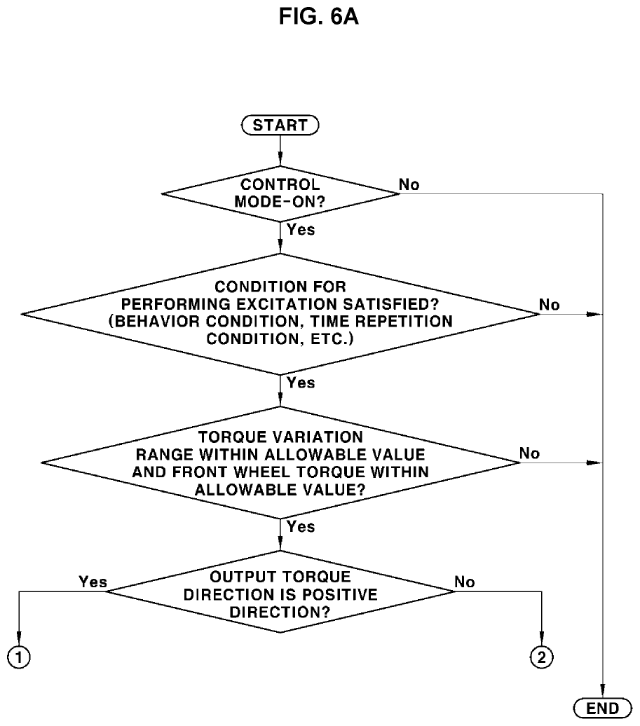

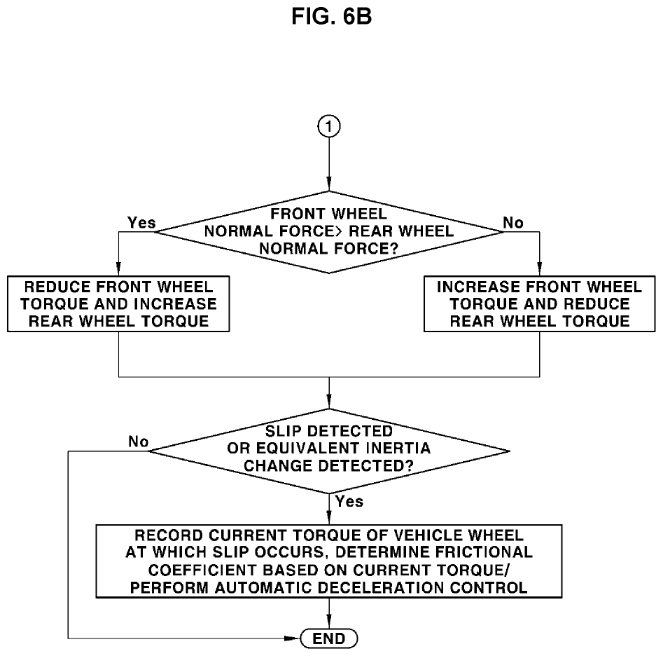

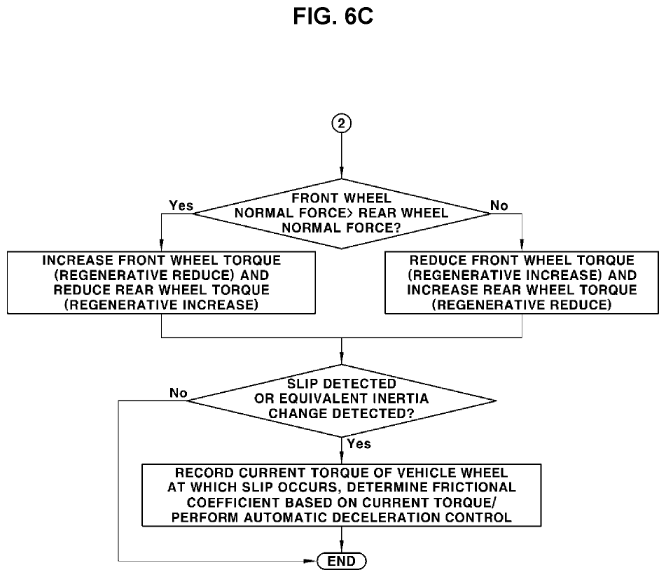

FIGS. 4A-4C illustrate an embodiment that employs the strategy 1) of maintaining a main driving wheel prior to excitation, FIG. 5 illustrates an embodiment that employs the strategy 2) of preventing rear wheel slip (oversteer), and FIGS. 6A-6C illustrate an embodiment that employs the strategy 3) of minimizing an estimated time.

The embodiments of FIGS. 4, 5, and 6 are the same in that the controller determines whether a current state is a control mode-on state by a driver, in the case of the control mode-on state, the controller determines whether a predetermined condition for performing torque excitation is satisfied based on current vehicle driving information, and when the condition for performing torque excitation is satisfied, the controller performs subsequent procedures.

In the embodiment of FIG. 4, when the condition for performing torque excitation is satisfied, the controller may determine a direction of the current output torque, and when output torque (required torque) is a positive (+) direction, the vehicle may be driven in the state in which the sum of torque of the front wheel and torque of the rear wheel is positive torque according to driver's intent of acceleration.

As such, when the condition for performing excitation is satisfied and a direction of output torque at a time when excitation is started is determined as a positive (+) direction, the controller may determine whether the front wheel torque distributed at the time point when excitation is started is larger than rear wheel torque.

Here, when the front wheel torque is larger than the rear wheel torque, whether the torque variation range is within an allowable value and the front wheel torque is within an allowable value, and then when both the values are within the allowable values, the front wheel torque (which is driving torque) may be increased based on a predetermined torque variation range, and the rear wheel torque (which is driving torque) may be reduced by the same torque variation range.

In contrast, when the rear wheel torque is larger than the front wheel torque, if whether the torque variation range is within the allowable range and the rear wheel torque is within the allowable range, and then bot the values are within the allowable values, the rear wheel torque (driving torque) may be increased based on a predetermined torque variation range, and the front wheel torque (driving torque) may be reduced by the same torque variation range.

When the rear wheel torque and the front wheel torque are the same, torque of one predetermined side (e.g., a front wheel) may be increased, and torque of an opposite side may be reduced.

When a direction of output torque is a negative (−) direction, the controller determines that the direction of the output torque is a negative (−) direction as a situation in which a vehicle brakes, and in this case, the controller determines whether the torque variation range is within an allowable range and whether the front wheel torque is within an allowable range, and then, when the both values are within the allowable values, the front wheel regenerative torque may be increased based on a predetermined torque variation range, and the rear wheel regenerative torque may be reduced by the same torque variation range.

Here, an increase in regenerative torque refers to an increase in regenerative torque based on an absolute value thereof, which mean that torque is reduced in a negative (−) direction.

In contrast, reduction in regenerative torque refers to reduction in regenerative torque based on an absolute value thereof, which means that torque is gradually increased from a negative (−) value.

This may be applied in a similar way to the embodiments of FIGS. 5 and 6 which will be described below.

As descried above, when torque excitation is performed, if slip is detected or an equivalent inertia change due to slip is detected, a road frictional coefficient may be determined using the current torque and normal force of the vehicle wheel at which slip occurs (equivalent inertia change occurs).

Then, deceleration control of automatically decelerating the vehicle based on a road frictional coefficient may be performed.

In the embodiment of FIG. 5, when the condition for performing torque excitation is satisfied, the controller may determine whether the torque variation range is within an allowable value and the front wheel torque is within an allowable value, and when bot the values are within the allowable values, the controller may determine a direction of the current output torque.

In this case, when output torque (required torque) is a positive (+) direction, the vehicle may be driven in the state in which the sum of torque of the front wheel and torque of the rear wheel is positive torque according to driver's intent of deceleration.

As such, the direction of the output torque at a time point when excitation is started may be determined, and in the case of a positive (+) direction, the front wheel torque (driving torque) may be increased base on a predetermined torque variation range, and the rear wheel torque (driving torque) may be reduced by the same torque variation range.

In contrast, When a direction of output torque is a negative (−) direction, the controller determines that the direction of the output torque is a negative (−) direction as a situation in which a vehicle brakes, and in this case, the front wheel regenerative torque may be increased based on a predetermined torque variation range, and the rear wheel regenerative torque may be reduced by the same torque variation range.

As described above, while torque excitation is performed, if slip is detected or an equivalent inertia due to slip is detected, a road frictional coefficient may be determined using the current torque and normal force of the vehicle wheel at which slip occurs (equivalent inertia change occurs).

Then, deceleration control of automatically decelerating the vehicle based on a road frictional coefficient may be performed.

Like in the embodiment of FIG. 5, in the embodiment of FIG. 6, when the condition for performing torque excitation is satisfied, the controller may determine whether the torque variation range is within an allowable value and the front wheel torque is within an allowable value, and when bot the values are within the allowable values, the controller may determine a direction of the current output torque.

In this case, when a direction of output torque at a time point when excitation is started is determined as a positive (+) direction, the amplitudes of the front wheel normal force and rear wheel normal force may be compared, and when the rear wheel normal force is smaller than the front wheel normal force, the rear wheel torque (driving torque) may be increased based on a predetermined torque variation range, and the front wheel torque (driving torque) may be reduced by the same torque variation range.

In contrast, when the front wheel normal force is smaller than the rear wheel normal force, the front wheel torque (driving torque) may be increased based on a predetermined torque variation range, and the rear wheel torque (driving torque) may be reduced by the same torque variation range.

When a direction of the output torque is a negative (−) direction, this is a situation in which the vehicle brakes, and in this case, the amplitudes of the front wheel normal force and rear wheel normal force may be compared with each other, and when the rear wheel normal force is smaller than the front wheel normal force, the rear wheel regenerative torque may be increased based on a predetermined torque variation range, and the front wheel regenerative torque may be reduced by the same torque variation range.

In contrast, when the front wheel normal force is smaller than the rear wheel normal force, the front wheel regenerative torque may be increased based on a predetermined torque variation range, and the rear wheel regenerative torque may be reduced by the same torque variation range.

As described above, while torque excitation is performed, if slip is detected or an equivalent inertia change due to slip is detected, a road frictional coefficient may be determined using normal force and the current torque of the vehicle wheel at which slip occurs (the equivalent inertia change occurs).

Then, deceleration control of automatically decelerating the vehicle based on a road frictional coefficient may be performed.

Accordingly, when the method of controlling driving of a vehicle according to the present disclosure is used, a road frictional coefficient while the vehicle travels may be estimated and driving of the vehicle may be controlled based on the estimated road frictional coefficient, thereby preventing excessive slip and a dangerous vehicle behavior on a low-friction road surface.

The present disclosure has been described in detail with reference to preferred embodiments thereof. However, it will be appreciated by those skilled in the art that changes may be made in these embodiments without departing from the principles and spirit of the present disclosure, the scope of which is defined in the appended claims and their equivalents.

1. A method of controlling driving of a vehicle by estimating a road frictional coefficient, the method comprising:
distributing torque to a front wheel and a rear wheel to satisfy required torque for driving, by a controller, in a four-wheel drive (4WD) vehicle including a front wheel driving device and a rear wheel driving device installed therein;
performing torque excitation control for increasing torque applied to one of the front wheel and the rear wheel to which the torque is distributed while the vehicle is driven, and simultaneously, changing torque applied to a remaining one of the front wheel and the rear wheel to satisfy the required torque by the sum of front wheel torque and rear wheel torque, by the controller; and
during the torque excitation control, when slip of the front wheel or the rear wheel is detected, estimating a frictional coefficient of a road surface with which a corresponding vehicle wheel is grounded from torque and normal force of a vehicle wheel at which slip is detected, by the controller.

2. The method of claim 1, further comprising:
controlling predetermined driving of the vehicle based on the estimated frictional coefficient of the road surface, by the controller.

3. The method of claim 2, wherein the controlling the predetermined driving of the vehicle includes determining a target speed corresponding to the estimated frictional coefficient of the road surface, and performing deceleration control on the vehicle using the determined target speed, by the controller.

4. The method of claim 1, wherein, when recognizing a control mode-on state selected by the driver, the controller controls the torque excitation and estimates the frictional coefficient of the road surface.

5. The method of claim 1, wherein the controller determines whether a predetermined condition for performing torque excitation is satisfied, from driving information collected from the vehicle; and
wherein, when determining that the predetermined condition for performing torque excitation is satisfied, the controller controls the torque excitation.

6. The method of claim 5, wherein, when a driver accelerator pedal input value, a brake pedal input value, required torque, vehicle inertia, and a driver steering input value are within respective predetermined ranges, the controller determines that the condition for performing the torque excitation is satisfied.

7. The method of claim 1, wherein the torque excitation includes one of a case in which driving torque of the front wheel is increased but driving torque of the rear wheel is reduced, a case in which driving torque of the rear wheel is increased but driving torque of the front wheel is reduced, and a case in which driving torque of the front wheel is increased but regenerative torque of the rear wheel is increased.

8. The method of claim 1, wherein the torque excitation includes one of a case in which driving torque of the rear wheel is increased but regenerative torque of the front wheel is increased, and a case in which regenerative torque of the front wheel is increased but regenerative torque of the rear wheel is reduced.

9. The method of claim 1, wherein, when detecting slip of the front wheel or the rear wheel while the torque excitation is controlled, the controller immediately stops the torque excitation and estimates a frictional coefficient of a road surface.

10. The method of claim 1, wherein the controller repeatedly performs an operation of controlling the torque excitation, and an operation of estimating the road frictional coefficient with a predetermined period while the vehicle travels at a constant speed.

11. The method of claim 1, wherein the controller linearly increases torque applied to one of the front wheel and the rear wheel with a predetermined inclination and changes torque applied to a remaining one of the front wheel and the rear wheel with the same inclination.

12. The method of claim 1, wherein the performing the control of the torque excitation includes:
determining whether required torque for driving of the vehicle is positive torque at a time point when the torque excitation control is started;
when the required torque is the positive torque, comparing front wheel torque with rear wheel torque; and
when the front wheel torque is larger than the rear wheel torque, performing the torque excitation control of increasing the front wheel torque and reducing the rear wheel torque.

13. The method of claim 12, wherein the performing the torque excitation control further includes torque excitation control of increasing rear wheel torque and reducing front wheel torque when the required torque is positive torque at a time point when the torque excitation control is started, if the rear wheel torque is larger than the front wheel torque.

14. The method of claim 12, wherein the performing the torque excitation control further includes torque excitation control of increasing front wheel regenerative torque and reducing rear wheel regenerative torque when the required torque is negative torque at a time point when the torque excitation control is started.

15. The method of claim 1, wherein the performing the torque excitation control includes:
determining whether the required torque for driving of the vehicle at a time point when the torque excitation control is started is positive torque; and
when the required torque is positive torque, performing torque excitation control of increasing front wheel torque and reducing rear wheel torque.

16. The method of claim 15, wherein the performing the torque excitation control further includes performing torque excitation control of increasing front wheel regenerative torque and reducing rear wheel regenerative torque when the required torque is negative torque at a time point when the torque excitation control is started.

17. The method of claim 1, wherein the performing the torque excitation control includes:
determining whether the required torque for driving of the vehicle is positive torque at a time point when the torque excitation control is started;
when the required torque is positive torque, comparing front wheel normal force with rear wheel normal force; and
when the front wheel normal force is larger than rear wheel normal force, performing torque excitation control of increasing rear wheel torque and reducing front wheel torque.

18. The method of claim 17, wherein the performing the torque excitation control further includes:
performing torque excitation control of increasing front wheel torque and reducing rear wheel torque when the required torque is positive torque at a time point when the torque excitation control is started, if the rear wheel normal force is larger than front wheel normal force.

19. The method of claim 17, wherein the performing the torque excitation control further includes:
when the required torque is negative torque at a time point when the torque excitation control is started, comparing the front wheel normal force with the rear wheel normal force; and
when the front wheel normal force is larger than the rear wheel normal force, performing torque excitation control of increasing rear wheel regenerative torque and reducing front wheel regenerative torque.

20. The method of claim 19, wherein the performing the torque excitation control further includes:
performing torque excitation control of increasing front wheel regenerative torque and reducing rear wheel regenerative torque when the required torque is negative torque at a time point when the torque excitation control is started, if the rear wheel normal force is larger than the front wheel normal force.
